(19) United States
(12) Patent Application Publication
(10) Pub. No.: US 2013/0326347 A1
(43) Pub. Date: Dec. 5, 2013

(54) APPLICATION LANGUAGE LIBRARIES FOR MANAGING COMPUTING ENVIRONMENT LANGUAGES

(71) Applicants: Eric Scott Albright, Sammamish, WA (US); Nicholas A. Beal, Bothell, WA (US); Peter Geoffrey Constable, Redmond, WA (US); Wade H. Curtiss, Kirkland, WA (US); Erik Fortune, Redmond, WA (US); Andrew Stuart Glass, Seattle, WA (US); Samuel Aaron Beard, Snohomish, WA (US)

(72) Inventors: Eric Scott Albright, Sammamish, WA (US); Nicholas A. Beal, Bothell, WA (US); Peter Geoffrey Constable, Redmond, WA (US); Wade H. Curtiss, Kirkland, WA (US); Erik Fortune, Redmond, WA (US); Andrew Stuart Glass, Seattle, WA (US); Samuel Aaron Beard, Snohomish, WA (US)

(73) Assignee: Microsoft Corporation, Redmond, WA (US)

(21) Appl. No.: 13/485,829

(22) Filed: May 31, 2012

(51) Int. Cl. G06F 17/00

(52) U.S. Cl. 715/265

(57) ABSTRACT

Language selection and application within a computing environment are often distributed over and differently applied by the operating system and various applications, leading to additional administration, inconsistencies in the user experience based on different language feature implementations among different applications; and increased cost and redundancy in developing language features for different applications. Presented herein are techniques for configuring a device with an application language library that centralizes the selection of languages by the user, and that provides a wide variety of language features (e.g., text translation, user interface adaptation, and data formats) to the applications and operating system. The application language library may also enable a multilingual user to select multiple languages; may apply a selection logic to choose a suitable language for each invocation of the application language library; and may enable the user to configure the selection among the languages for various types and instances of invocations.

### BACKGROUND

In the field of computing, many scenarios involve a computing environment configured to communicate with a user in a natural or artificial language. The selection of a language may alter many aspects of the computing environment, such as the language of texts presented to the user; the types of user interfaces presented to the user (e.g., an on-screen keyboard may present a character set and key layout matching the user's language); and the formats of data presented to the user (e.g., various ways of displaying dates, such as mm-dd-yyyy or dd-mm-yyyy; different units of measurement, such as imperial vs. metric units; and monetary value presented in a local currency).

Language settings may be utilized by many applications, including the operating system of the device, and in many contexts. In many computing environments, the operating system may enable the user to select a language, and may endeavor to adjust the computing environment for that language. An application executing within the computing environment may be configured to identify the language selected by the user within the operating system, and to adjust the presentation of the application based on the selected language. Alternatively, the application may present a separate language selection mechanism, and may apply a language selection by the user to adjust the presentation of the application in different contexts (e.g., a document editor may present sets of fonts corresponding to the language of the user; a web browser may utilize a language selection of the user in an HTTP Accept-Language parameter while communicating with webservers; and a speech-enabled application may select linguistic parameters based on the language of the user). In some computing scenarios, several applications may independently solicit language selection and apply the language selections in different contexts, irrespective of other language selections by the user within other applications and the operating environment.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The configuration of applications and an operating environment to solicit and utilize language settings in a comparatively disconnected manner may present many disadvantages. As a first example, configuring an application to present and utilize language settings may be a complex and resource-intensive task. Many applications may provide limited or no support for language settings; may implement language features incorrectly or inconsistently; or may implement language features at the expense of other features and/or a higher development cost. In general, a computing environment that provides inadequate language selection and adaptation features for applications leads to the redundant development of similar language resources for different applications. As a second example, when applications provide separate selections and implementations of language features rather than sharing such information and functionality, a user may have to configure the language settings individually within the operating system and each application, thus raising the administrative complexities of the computing environment. Additionally, users may experience inconsistencies in the language features presented by different applications (e.g., different applications may present keyboards with different character sets and key layouts to the user), reducing the consistent experience of the user within the computing environment. As a third example, a multilingual user may wish to utilize different languages in different contexts, or to adjust some language variants of a selected language (e.g., requesting an American English language but a dd-mm-yyyy formatting of dates in a European manner), but the language features of the operating system and applications may not adequately support such selections.

Presented herein are techniques for configuring a device to solicit and utilize the selection of languages. In accordance with these techniques, the device may provide an application language library that centralizes the user's selection and customization of language information, including the selection of particular dialects of a language; the selection of multiple languages and the logic for choosing among such selections for a particular context; and the customization of language features of a selected language. The application language library may utilize these selections to provide a wide variety of services to the computing environment, including the operating system and the applications executing therewithin. For example, an application may request the application language library to present a selected text as a text version in a selected language of the user, and optionally to translate the text automatically into a selected language of the user; to present a user interface (such as an on-screen keyboard, a calculator, or a calendar) according to the user interface variants of a selected language of the user; and to format data types (such as dates, measurements, and currencies) according to the standards of a particular language or culture. These sophisticated features may be presented to all applications, thus enabling a sophisticated consistent presentation of language features in many applications without entailing development costs for each application. Additionally, the selection or updating of selected languages within the application language library may be automatically propagated throughout the computing environment to achieve a consistent user experience. These and other advantages may be achieved by presenting and exposing language features through a centralized application language library in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a device configured to present a computing environment according to a set of language settings for respective applications.

FIG. 2 is an illustration of an exemplary scenario featuring a device configured to present a computing environment through an application language library in accordance with the techniques presented herein.

FIG. 3 is a flow chart illustrating an exemplary method of presenting applications within a computing environment through an application language library in accordance with the techniques presented herein.

FIG. 4 is an illustration of an exemplary computer-readable medium comprising processor-executable instructions configured to embody one or more of the provisions set forth herein.

FIG. 5 is an illustration of an exemplary scenario featuring a selection of a language for an invocation from a set of selected languages.

FIG. 6 is an illustration of an exemplary scenario featuring a set of user interface variants for respective languages.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. INTRODUCTION

Within the field of computing, many scenarios involve communication with a user through a selected language that may be supported by the device. For example, a multilingual device may be capable of communicating with users in English, French, and Spanish, as well as regional dialects of these languages (such as American English and UK English), and, upon a user selecting a desired language, may adjust the output and/or parsing input to utilize text in the selected language. Other features of the text may also be adapted, such as a presented direction of text matching the selected language (e.g., horizontal left-to-right, horizontal right-to-left, horizontal bidirectional, and vertical left-to-right). User interfaces may be adapted based on the language selection; for example, the character set and key layout of an on-screen keyboard may reflect the language and cultural standards of a particular language, such as the ANSI mechanical layout for users of American English; the ISO mechanical layout for users of UK English; and the JIS mechanical layout for users of Japanese. Additional features of the device may also be adapted based on the selection, such as the presentation of measurements in metric, imperial, Troy, or other measurement systems; the presentation of value in a currency format associated with the selected language; and the presentation of dates according to the cultural standards associated with the selected language (e.g., the mm-dd-yyyy formatting of dates in the American style, or the dd-mm-yyyy formatting of dates in the UK style).

A device may be configured to enable a user to select a language, and to utilize the selected language throughout the computing environment presented by the device. For example, an operating system of a computer may present a control panel and help documentation in the language selected by the user, and to communicate with the user through user interfaces based on the selected language. Additionally, the device may feature a set of applications that may be installed and executed within a computing environment. These applications may also enable the user to select a language, and may be configured to apply the selected language within the application. These applications may also query the operating system for a selected language, or for particular language features selected by the user (e.g., a preferred date format), and may accordingly adjust the user interfaces of the application. Alternatively, the application may provide an application- and context-specific user interface for enabling the user to select a language (e.g., a text editor may enable a user to select a language dictionary for the spell-check feature). Each application may therefore solicit and apply the language selections according to the specific context of the application.

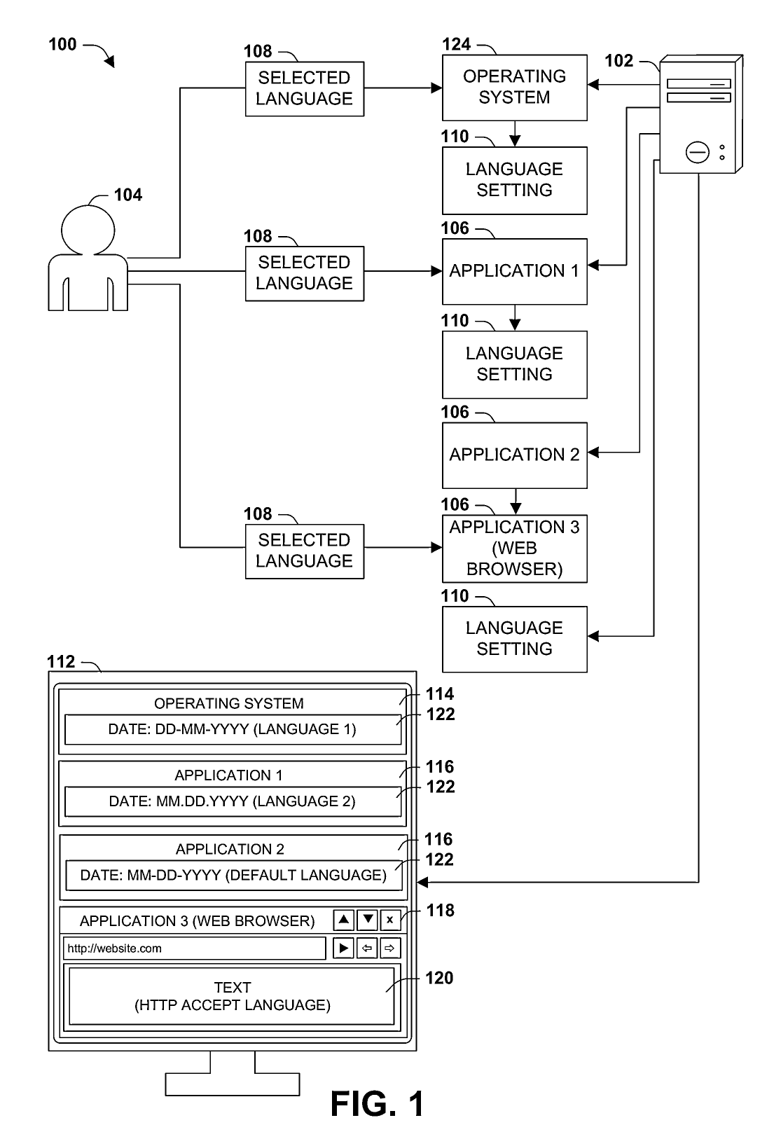

FIG. 1 presents an illustration of an exemplary scenario featuring a device 102 configured to interact with a user 104 through a set of applications 106 according to a variety of languages 108. For example, the device 102 may present an operating system 124 and a set of applications 106 configured to request or enable the user 106 to select a language 108, and to adapt the user interfaces of the operating system 124 and applications 106 presented on a display 112 of the device 102 according to the selected language 108. (Throughout this application, references to an application 106 may also be construed as a reference to the operating system 124 executing on the device 102.) More particularly, the user 104 may separately perform the selection of languages 108 for the operating system 124 and each application 106, and each may store a set of language settings 110 that are consumed by the respective operating system 124 and applications 106, and that are oriented toward the respective contexts of the operating system 124 or application 106. For example, the operating system 124 may store a comprehensive set of language settings 110, such as a selected communication language and a selected date format for presenting the date within the environmental user interfaces of the operating system 124 (such as a system calendar); a first application 106 may only store a language selected by the user 104 for adjusting the user interface of the first application 106; a second application 106 may not enable the user even to select a language 108, and may operate the same irrespective of a selection of any language 108 in the operating system 124 or elsewhere; and a third application 106 may only use a selected language 108 internally (e.g., a web browser may only use a selected language 108 to specify an appropriate HTTP accept language parameter while interacting with webservers). In this manner, a user 104 may separately interact with the respective applications 106 and the operating system 124 to adapt various features based on the language 108 selected by the user 104.

While the configuration of a device 102 to solicit and apply language selections according to exemplary scenario 100 of FIG. 1 may present some advantages, such configurations may also present a variety of disadvantages. As a first example, in this configuration, each of the operating system 124 and respective applications 106 stores a separate set of language settings 110 based on the particular selection of the language 108 by the user 104 within the operating system 124 or application 106. Thus, the user 104 has to interact with each application 106 and the operating system 124 separately to perform and manage such selections; and when such selections are not synchronized, the languages and standards used by the device 102 may vary across applications 106 and the operating system 124. For example, a user 104 may select a language 108 in the operating system 124, but this selection may not be conveyed to an application 106 that continues to use the language 108 specified in the language settings of the application 106. As a second example, the operating system 124 and applications 106 may utilize such selections in an inconsistent manner; e.g., the operating system 124 may adjust many aspects of its user interfaces based on a selected language 108, but the first application 106 may present the same user interfaces (such as on-screen keyboard) irrespective of any language selection by the user 104, while the second application 106 may present no adaptability, thus creating an inconsistent user experience within the computing environment. For example, the operating system 124 may present an operating system interface 114 that includes a date format 122 formatted according to the language 108 specified in the language settings 110 of the operating system 124, in accordance with a selection received from the user 104 while interacting with the operating system 124. However, the first application 106 may present an application user interface 116 featuring a different date format 122 according to a different language 108 specified in the language settings 110 of the first application 106, in accordance with a selection received from the user 104 while interacting with the first application 106. The second application 106 may not support language selection, and may present an application user interface 116 featuring a third date format 122 according to the default language of the second application 106, irrespective of any selection of languages 108 in the operating system 124 or any other application 106. Additionally, a third application 106, comprising a web browser, may contain a separate set of language settings 110 that are used only internally, and may represent a selected language 108 as an HTTP accept language parameter 120 while communicating with webservers, which may respond by providing text in the specified language 108. The web browser 118 may therefore present content in a completely different language 108, and if the user 104 has forgotten or is unaware of the language settings 110 of the web browser 118, the user 104 may be unable to determine why text is being presented in this language 108 (i.e., whether the language 108 has been specified by the operating system 124 or one of the applications 106) or to reconfigure the web browser 118 to present the text in a different language 108.

Additional disadvantages may arise from the limited coordination of the operating system 124 and applications 106 in the use of language selections. For example, it may be appreciated that the development of a sophisticated set of language features for a potentially wide variety of languages and cultures is a resource-intensive and complicated process. Therefore, it may be inefficient to configure the device 102 such that the developer of each application 106 has to create such language features for each application 106. In addition to creating inconsistency among applications 106, this inefficiency may divert developer resources from the development of other features of the application 106, and/or may raise the costs of developing and supporting the application 106. Additionally, the user 104 may wish to adjust the application of a selected language 108 (e.g., by selecting different languages 108 for different contexts, or by adjusting some features of a selected language 108, such as selecting American English but requesting metric units and a UK-style date format). However, the configuration of the device 102 such that each application 106 independently receives and applies the selection of languages 108 may not be sufficiently sophisticated to support such user customization, particularly in a manner exceeding the context of a particular application 106 or the operating system 124. The developer may choose to generate different versions of the application 106 that respectively present one language 108, but these versions may diverge over time, and a user 104 who wishes to switch the application 106 from a first language 108 to a second language 108 may have to retrieve and install an entirely different version of the application 106. Alternatively, if a developer of an application 106 chooses not to provide language features, the application 106 may be unresponsive to the selection of languages 108 by the user 104, and may thus become incomprehensible or unusable for the user 104. These and other disadvantages may result from inadequate coordination among the operating system 124 and the applications 106 in supporting users' selection of languages 108 due to the configuration of the device 102 as presented in FIG. 1.

### B. PRESENTED TECHNIQUES

Presented herein are techniques for configuring a device 102 to receive and apply the selection of languages 108 in a manner that may reduce the disadvantages presented in the exemplary scenario 100 of FIG. 1. In accordance with these techniques, the device 102 may feature an application language library that is configured to receive one or more selected languages 108 from the user 104 and provide an array of language-related services to the applications 106 (including the operating system 124). By centralizing the user's selection of languages 108 in a single application library, and by invoking the application library to apply these selections broadly across the services provided by the operating system 124 and the applications 106 executing therein, this configuration may present significant advantages in the consistency, accuracy, and sophistication of supported languages, as well as significantly greater functionality and efficiency by providing such services to all applications 106 rather than encumbering the developers of such applications 106 with the implementation of such functionality.

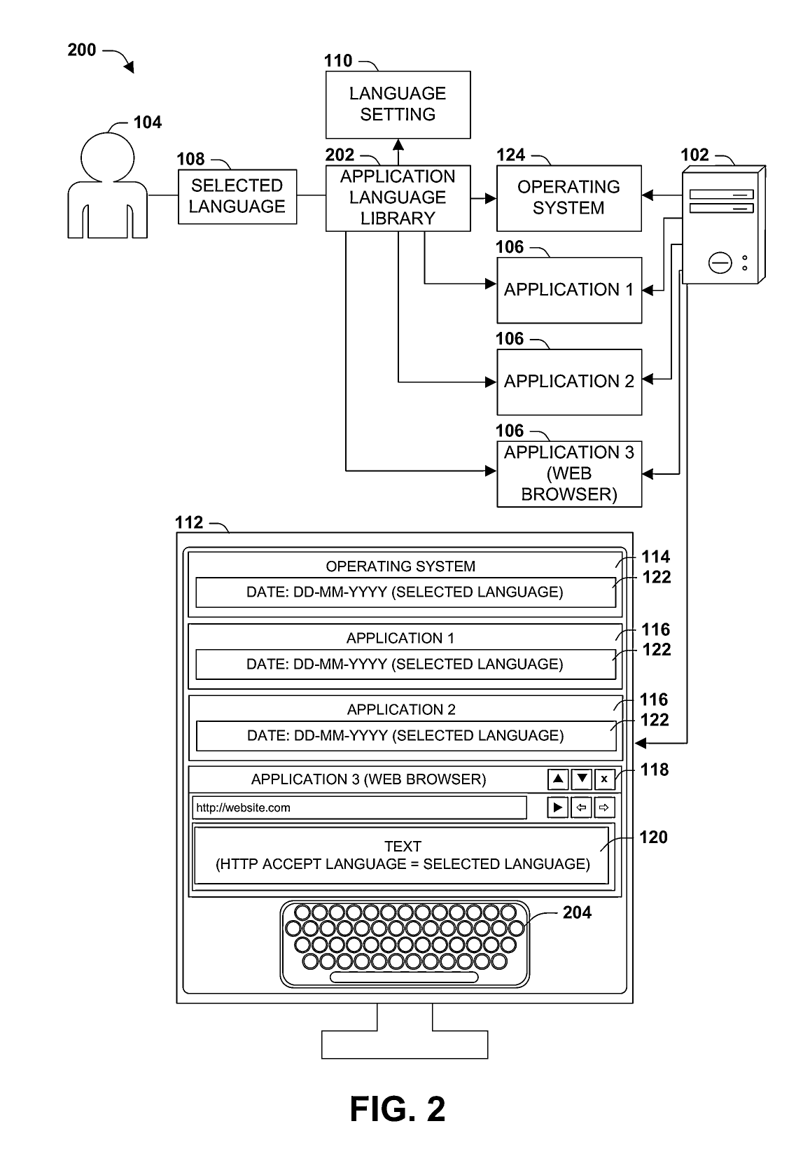

FIG. 2 presents an illustration of an exemplary scenario 200 featuring a configuration of a device 102 according to the techniques presented herein. In this exemplary scenario 200, a device 102 executes an operating system 124 and a set of applications 106 therewithin. The user 104 may again select a language 108 or a set of language settings to be used by the device 102 to be used while presenting various user interfaces on a display 112 of the device 102 on behalf of a user 104. However, in contrast with the exemplary scenario 100 of FIG. 1, in this exemplary scenario 200, the user's selection of a language 108 is received and stored by an application language library 202 included in the device 102. The application language library 202 in turn provides a broad set of services to the applications 106 (including the operating system 124) based on the languages 108 selected by the user 104. As a first example, the application language library 202 may enable text provided by an application 106 to be presented in one of the languages 108 selected by the user 104, and in accordance with language text variants of the selected language 108, such as text direction. As a second example, the application language library 202 may receive a request by an application 106 to present a user interface 204, and may present the user interface with user interface variants corresponding to a language 108 selected by the user 104 (e.g., receiving a request to provide an on-screen keyboard, and presenting an on-screen keyboard featuring a character set and key layout matching a selected language of the user 104). As a third example, the application language library 202 may receive a request by an application 106 to format a data type (e.g., preparing a date value for presentation, or parsing a date value specified by the user 104), and may fulfill the request using a data format of the data type that corresponds to a language 108 selected by the user 104 (e.g., presenting and parsing dates according to an American-style format, such as mm-dd-yyyy, rather than a UK-style format, such as dd-mm-yyyy). These and other services may be provided by the application language library 202 on behalf of the applications 106 (including the operating system 124) through the configuration of the techniques presented herein.

The configuration of the device 102 in this manner may present several advantages when compared with the configuration of the device 102 in the exemplary scenario 100 of FIG. 1. As a first example, instead of different applications 106 presenting different languages 108 due to different per-application language settings 110 and/or separate language selections by the user 104 with each application 106, the device 102 in FIG. 2 presents a selected language 202 received by the application language library 202 throughout the computing environment. As a second example, the application language library 202 may present the same language adjustments, such as text language variants (e.g., text direction), user interface variants of user interfaces 204 (e.g., character sets and key layouts of on-screen keyboards), and formats of data types, throughout the computing environment, rather than different applications 104 implementing a language selection in a different manner. As a third example, the centralization of language selection in the application language library 202 may enable a sophisticated selection logic, such that a multilingual user 104 may select several languages 108; may specify a logic for selecting among these languages 108 for various invocations of the application language library 202 by different applications 106; and/or may adjust the details by which a selected language 108 is utilized (e.g., selecting an American English language but specifying that dates are to be formatted according to a UK-style date format). For a particular invocation by an application 106, the application language library 202 may apply selection logic to choose, from among the selected languages 108, a language 108 that is suitable for the invocation. As a fourth example, by providing these language features in an application language library 202 (which may be included with the device 102 and/or operating system 124), this configuration alleviates developers from the resource commitment and difficulty of implementing the language features for a specific application 106, thus improving the efficiency of application development for the device 102 and/or operating system 124. These and other advantages may be achievable through the configuration of the device 102 and/or operating system 124 as illustrated in the exemplary scenario 200 of FIG. 2, in accordance with the techniques presented herein.

### C. EXEMPLARY EMBODIMENTS

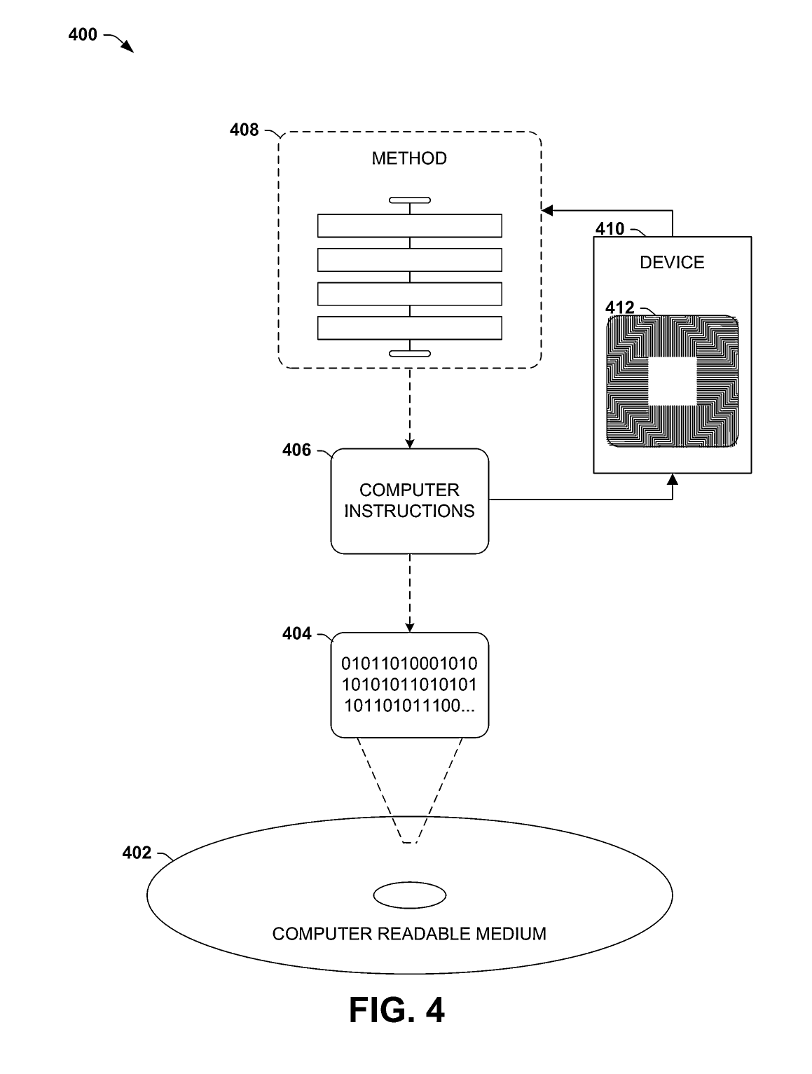

FIG. 4 presents a first exemplary embodiment of the techniques presented herein, illustrated as an exemplary method 400 of configuring a device 102 to receive and apply a selection of languages 104. The instructions may be implemented, e.g., as a set of instructions stored in a memory component of the device 102 (e.g., a memory circuit, a platter of a hard disk drive, a solid-state storage device, or a magnetic or optical disc) that, when executed on a processor of the device 102, causes the device 102 to perform the techniques presented herein. The exemplary method 400 begins at 402 and involves executing 404 the instructions on the processor of the device 102. In particular, the instructions are configured to present 306 to the user 104 a set of available languages 108. The instructions are also configured to, upon receiving 308 from a user 104 a selection of a language 108 including a set of language settings, configure the application language library 202 to use the selected language 108 to provide language services to the operating system 124 and applications 106 using the selected language 108. In particular, the instructions are configured to, upon receiving a text, among a set of text versions of the text in respective languages 108, present 310 a text version of the text in a selected language 108. The instructions are also configured to, among a set of user interfaces 204 associated with respective languages 108, present 312 a user interface 204 associated with a selected language 108 (e.g., presenting a user interface 204 featuring user interface variants corresponding to a selected language 108, such as an on-screen keyboard presenting a character set and key layout matching the selected language 108). The instructions are also configured to, upon receiving a data type, among a set of data formats 122 associated with respective languages 108, present 314 the data type in a data format 122 associated with a selected language 108 (e.g., presenting a date that is formatted in a date style of a selected language 108). The instructions are also configured to configure 316 applications 108 interacting with users 102 of the device 102 to invoke the application language library 202 for language-related services. In this manner, the exemplary method 400 of FIG. 4 causes the device 102 to receive and apply the selection of languages 108 according to the techniques presented herein, and so ends at 318.

Another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

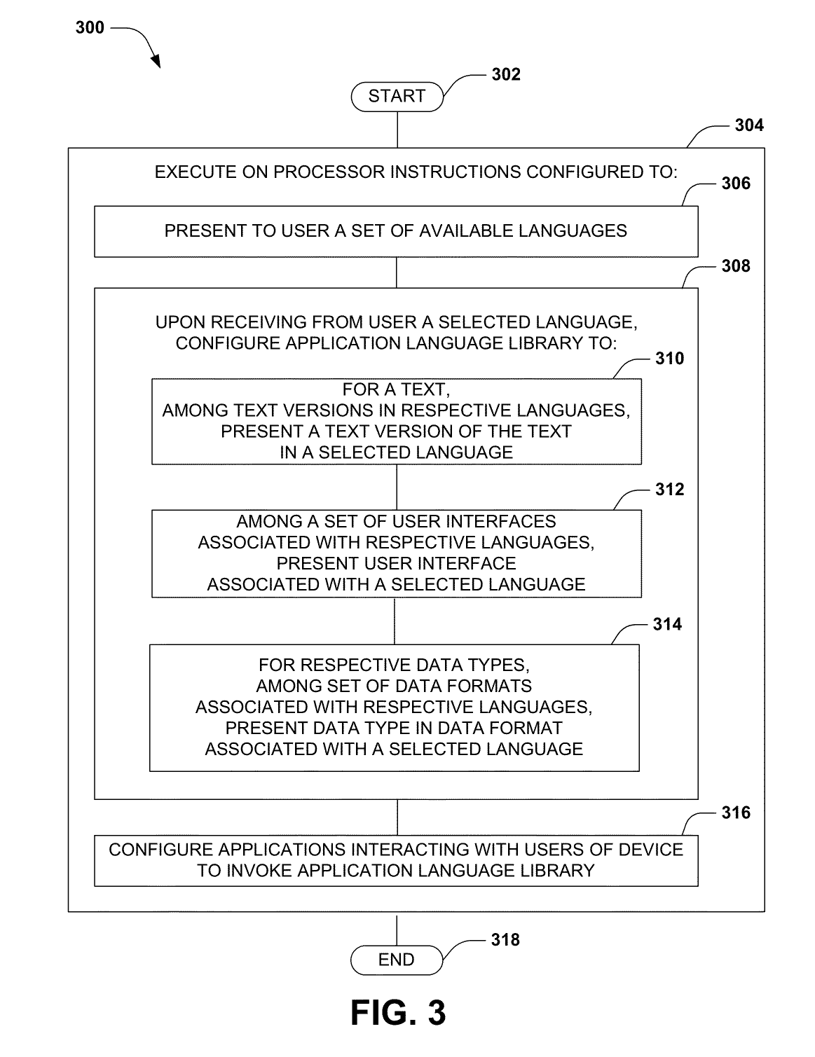

An exemplary computer-readable medium that may be devised in these ways is illustrated in FIG. 4, wherein the implementation 400 comprises a computer-readable medium 402 (e.g., a CD-R, DVD-R, or a platter of a hard disk drive), on which is encoded computer-readable data 404. This computer-readable data 404 in turn comprises a set of computer instructions 406 configured to operate according to the principles set forth herein. Some embodiments of this computer-readable medium may comprise a computer-readable storage medium (e.g., a hard disk drive, an optical disc, or a flash memory device) that is configured to store processor-executable instructions configured in this manner that, when executed on a processor 412 of a device 410, cause the device to perform the techniques presented herein. For example, the processor-executable instructions 406 may be configured to cause the device 410 to perform a method of applying a language 108 selected by a user 104, such as the exemplary method 300 of FIG. 3. Many such computer-readable media may be devised by those of ordinary skill in the art that are configured to operate in accordance with the techniques presented herein.

### D. VARIATIONS

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3) to confer individual and/or synergistic advantages upon such embodiments.

D1. Scenarios

A first aspect that may vary among embodiments of these techniques relates to the scenarios wherein such techniques may be implemented.

As a first variation of this first aspect, the techniques presented herein may be applied with many types of devices 410, such as workstations; servers; consoles; and mobile devices such as notebook computers, palmtop computers, mobile phones, portable media players, and portable gaming devices. Additionally, the techniques presented herein may be applied to provide language services by the application language library 202 to a wide set of applications 106, such as operating systems 124; productivity applications, such as text readers and editors; media viewers and editors; games; application development tools; and emulators of other devices and computing environments.

As a second variation of this first aspect, the techniques presented herein may be implemented using various architectures. As a first example, the application language library 202 may be provided by the device 104, by the operating system 124, or by another application 106, or may comprise a standalone application 106 or library that is separately installed on the device 104. As a second example, the application language library 202 may be implemented as a hardware component (e.g., a circuit embedded in or inserted into the device 102), a software component that is installed within the computing environment of the operating system 124, or a combination thereof. As a third example, the application language library 202 may directly fulfill each invocation (e.g., receiving from an application 106 a request to present text, and responding by presenting the text version of the text in a selected language 108 on the display 112 of the device 102), or may provide resources to the application 108 (e.g., returning the text version associated with a selected language 108 to the invoking application 106, which may determine how to present the text).

As a third variation of this first aspect, the techniques presented herein may be applied to enable users to select among a variety of languages. While the examples presented herein utilize naturally arising human languages such as English, French, and German, the techniques may also be adapted to enable the selection of a range of natural and artificial languages usable in a range of contexts such as print, verbal, and gestural communication with other users and/or devices. For example, the concepts presented herein may be applied for the selection of artificially designed languages such as Esperanto; fictional languages such as pirate and Klingon; gestural languages such as American Sign Language and semaphore; tactile languages such as Braille; language encodings such as Morse; and functional languages such as C and Java. The techniques presented herein may enable many such types of selections, and may involve configuring the application language library to adapt the computing environment in various ways to reflect such decisions. These and other scenarios and variations may be compatible with the techniques presented herein.

D2. Language Selection

A second aspect that may vary among embodiments of these techniques involves the manner in which the application language library 202 accepts a selection of a language 108 from a user 104.

As a first variation of this second aspect, the device 102 may be configured to solicit and/or receive a first selection of a language 108 from the user 104. As a first such example, the device 102 may be configured to present to the user 104 a set of available languages 108 upon detecting a new user 104 of the device (e.g., either the first user 104 to access the device 102 upon activation, or a different user 104 of a device 102 that is already in use by others). As a second such example, the device 102 may identify at least one language 108 as a default language, and may, before receiving a selection of a language 108 from the user 104, utilize the default language as the selected language 108. The default language may be selected, e.g., based on a native language of the manufacturer of the device 102, or a country of distribution where the device 102 is likely to be first utilized. As a third such example, the device 102 may be configured to infer a selection of a language 108 based on various factors. For example, the device 102 may identify a location associated with the user 104 (e.g., through a selection by the user 104 of his or her home location, or through a user profile of the user 104, such as a social network profile), and to select a language 108 that is associated with the location. As another example, the device 102 may be configured to receive a type of user input from the user 104 (e.g., the user's name, an entry of text, or a speech segment), and to infer a selected language of the user 104 based on the user input (e.g., inferring a user's nationality and native language based on his or her name, or applying a natural-language parser to any input provided by the user 104 to identify the language of the user input).

As a second variation of this second aspect, the device 102 may be configured to permit a user 104 to select a set of languages 104. For example, a multilingual user 104 may indicate all of the languages 108 in which the user 104 is fluent, and for any particular invocation, the application language library 202 may select any suitable language 108. Alternatively, a user 104 may specify several languages 108, but may specify that some invocations of the application language library 202 are to use a first language 108 rather than a second language 108 (and, optionally, that some other invocations of the application language library 202 are to use the second language 108 rather than the first language 108). The user 104 may present, and the application language library 202 may apply, a potentially complex selection logic for determining the language 108 to be used for specific invocations. For example, the application language library 104 may be configured to select a particular language 108 for specific types of invocations (e.g., user interfaces 204 are to be presented according to user interface variants for a first language 108, and text is to be presented in a second language 108); a particular application or an application type (e.g., media presenting applications or games); an operating environment of the device 102 (e.g., different languages 108 to be used when the device is operating at a specific location, or in a public environment or a private environment); for different times (e.g., a first language 108 to be used in daytime and a second language 108 to be used in the evening); or in the presence of particular individuals.

As a third variation of this second aspect, particularly relating to the user selection of multiple languages 108, the application language library 202 may be configured to utilize a selection order to select a language 108 from among the selected languages 108 for a particular invocation. For example, the device 102 may identify a selection order of selected languages 108, based on criteria such as the user's fluency in the language 108, the compatibility of the language 108 with the device 102, and the accuracy and efficiency with which the device 102 is capable of rendering the language 108, that directs the selection logic of the application language library 202. When presented with an invocation, the application language library 202 may initially select the first language 108 in the selection order to fulfill the invocation; and if the first language 108 is unsatisfactory or incompatible with the invocation, the application language library 202 may select the second language 108 in the selection order to retry the same invocation or to perform the next invocation, etc. For example, the device 102 may be configured to, for a particular invocation by an application 106, compute for each language 108 a selected language weight representing the suitability of the selected language 108 for the invocation, and to utilize for the invocation the selected language 108 having the highest selected language weight. If the selected language 108 having the highest selected language weight is partially or completely incompatible with the invocation, the application language library 202 may request the next language 108 in the selection order, which may present a higher degree of compatibility.

Additional variations involve adjusting the selection order of the selected languages 108 to raise the flexibility of the application language library 202. As a first example of this third variation, a first language 108 may be associated with a fallback language, such that if the first language 108 is not suitable for a particular invocation (e.g., a language 108 for which a translation of a presented text is unavailable), the fallback language may be selected instead. The fallback language may comprise, e.g., a language 108 that is often familiar to users of the first language 108; e.g., users 102 who are fluent in American English may also understand UK English, while users 102 who are fluent in Catalan are often familiar with Spanish. Accordingly, when a first language 108 is inserted into the selection order of the application language library 202, a fallback language that is associated with the first language 108 may also be inserted into the selection order (after the first language 108).

As a second example of this third variation, a selected language 108 may comprise a language dialect of a generalized language 108, such as American English (language code en-US) as a regional dialect of the English language (language code en), or related dialects, such as UK English (language code en-GB). When the language dialect is inserted into the selection order, a generalized language or related dialect of the language dialect may also be inserted into the selection order (after the language dialect).

As a third example of this third variation, the application language library 202 may insert a default language into the selection order to be used if all of the selected languages 108 are unsuitable for an invocation, such as a default language generally specified by the application 108 or operating system 124, specified with a particular invocation, and/or specified by the device 102. In this manner, the application language library 202 may be configured to fulfill invocations using a suitable language selected from among several languages 108 that may be usable by the user 102.

As a fourth variation of this second aspect, the user 104 may be permitted to alter the configuration of the application language library 202 in the selection of languages 108.

As a first example of this fourth variation, respective languages 108 may be associated with a set of language variants (e.g., a print language used to select text versions of text, a set of user interface variants to be selected for user interfaces 204, and a set of data formats 122 for respective data types) to be used when the application language library 202 selects the languages 108. However, a user 104 may initiate a request to configure the application language library 202 to use a different set of language variants for a particular language 108. For example, the user 104 who selects American English may approve several of the default language variants for this language 108 (e.g., the user of American English as the print language for text, and the presentation of user interfaces 204 with user interface variants that are associated with American English), but may wish to adjust some of the data formats 122 associated with this selected language 108 (e.g., the user 102 may request the UK-style date format of dd-mm-yyyy over the US-style date format of mm-dd-yyyy, or the use of metric units instead of imperial units). The application language library 202 may fulfill such requests by accordingly configuring the selected language 108 to use the language variants specified by the user 104. These options may be presented, e.g., in a language settings interface of a control panel that provides various settings for the device 102, which may present the user 104 with a list of available languages, may enable the user 102 to choose list items to alter the set of selected languages; and/or alter the language variants of respective languages 108.

As a second example of this fourth variation, the application language library 202 may permit the user 104 to alter the selection order 514 and/or other selection logic for choosing a selected language 108 for a particular invocation.

As a third example of this fourth variation, the user 108 may specify a particular language 108 to be used by the application language library 202 for a particular invocation. For example, upon presenting a first user interface 204 in a particular language 108, the device 102 may enable the user 104 to select a different language 108 (e.g., by right-clicking the first user interface 204 with a pointing device to display a context menu featuring the set of selected languages, and then selecting a different language 108), and may then replace the first user interface 204 with a second user interface 108 associated with the selected language. These and other variations may be included in the configuration of an application language library 202 to support and utilize a set of selected languages 108 while implementing the techniques presented herein.

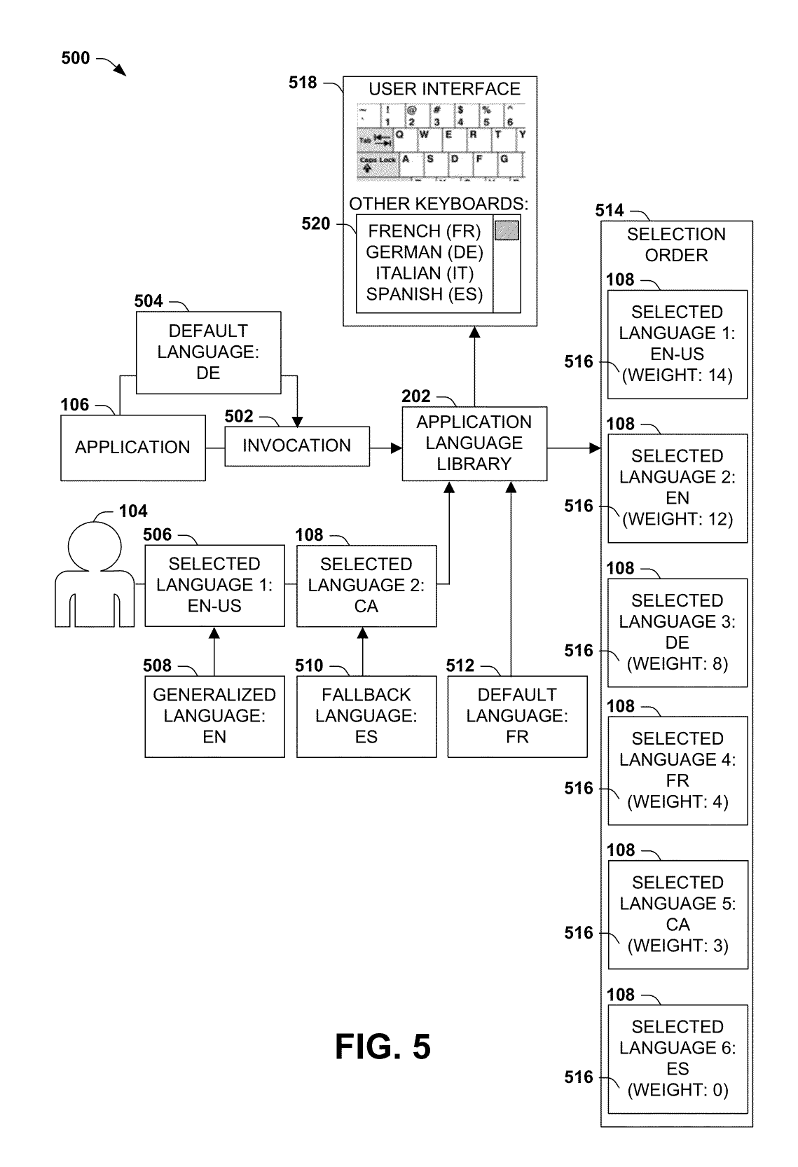

FIG. 5 presents an illustration of an exemplary scenario 500 featuring an application language library 202 configured to fulfill invocations 502 received from applications 106 (including the operating system 124) by selecting a language 108 from among various selected languages 108 using several of these variations of this second aspect. In this exemplary scenario, the application 106 specifies for the application language library 202 a default language 504 of the invocation 502 (e.g., the native language of the invocation 502, such as German). The user 104 selects a primary language 506 (American English), and the application language library 202 endeavors to fulfill invocations using the user's primary language 506. However, the user 104 also selects another language 108 (e.g., Catalan) that the application language library 202 may suitably select for some invocations 502. Additionally, the primary language 506 of the user 104 is a dialect of a generalized language 508 (e.g., English), and the other language 108 selected by the user 104 may be associated with a fallback language (e.g., Spanish). The device 102 and/or application language library 202 may also identify a default language 512, such as a language in which the device 102 is particularly well-equipped or proficient (e.g., French).

As further illustrated in FIG. 5, in order to provide a suitable selection among these several languages 108, the application language library 202 may generate and/or refer to a selection order 514, where the selected languages 108 are ordered according to a weight 516 indicating the order in which languages 108 are to be selected in order to fulfill a particular invocation 502. The application language library 202 may then fulfill the invocation 502 by selecting the language 108 in the selection order 514 having the highest weight 516 and that is compatible with the invocation 502. For example, the device 102 may, upon receiving an invocation 502 requesting a presentation of an on-screen keyboard 518, select and present an on-screen keyboard with the character set and key layout of the highest weighted selected language 108 (e.g., the ANSI mechanical layout that is popular among speakers of American English). Moreover, the on-screen keyboard 518 may be presented with a control 520 enabling the user to select a different language 108 (optionally presented according to the selection order 514), and, upon receiving a selection by the user 102 of a language 108 within this control 520, may replace the on-screen keyboard 518 with a different on-screen keyboard 518 matching the selected language 108. In this manner, application language library 202 may utilize a sophisticated selection logic to choose among the selected languages 108 in order to fulfill the invocation 502, while also enabling the user 104 to override the selection for the invocation 502 by specifying a different language 108.

D3. Language Use

A third aspect that may vary among embodiments of these techniques relates to the services provided by the application language library 202 in response to invocations 502 by various applications 106 (including the operating system 124).

As a first variation of this third aspect, the application language library 202 may choose many ways of presenting a text as a text version associated with a selected language 108. As a first example of this first variation, the text presented or referenced by the invocation 502 may be available in multiple text versions for respective languages 108, and the application language library 102 may retrieve the text version associated with a selected language 108. Alternatively, the device 102 may have access to a set of human and/or automated translation services, and in order to present a text version of a text in a selected language 108, the application language library 202 may invoke a translation service associated with the selected language 108 to generate a translated version of the text in the selected language 108, and may present the translated version of the text.

As a second variation of this third aspect, the application language library 202 may utilize other language variants of a selected language 108 in order to present text in an accurate manner. For example, a print language may be associated with a text direction, such as left-to-right horizontal text, right-to-left horizontal text, bidirectional horizontal text, or vertical text. While presenting text in a selected language 108, application language library 202 may adjust the presentation using the appropriate text direction.

As a second variation of this third aspect, the application language library 202 may utilize many types of user interface variants in presenting a user interface according to a selected language 108, such as a character set and/or a key layout associated with the selected language 108 for an on-screen keyboard 518; a textbox presenting entered text according to the text direction of the selected language 108; and a language dictionary associated with the selected language 108 (e.g., a configuration of a text editor to use an appropriate spell-checking and grammar dictionaries for the selected language, and the configuration of a speech interpreter to parse input speech according to one of the selected languages, or even a combination of languages in mixed speech). Other user interface variants may also be adjusted based on the selected language 108; e.g., a simulation of a book may advance through the book by visually presented pages flipping left-to-right or right-to-left based on the text direction, and a media player may use a left arrow and right arrow to represent reversing or advancing through a media object for languages 108 having a left-to-right text direction, and may switch these controls for languages 108 having a right-to-left text direction.

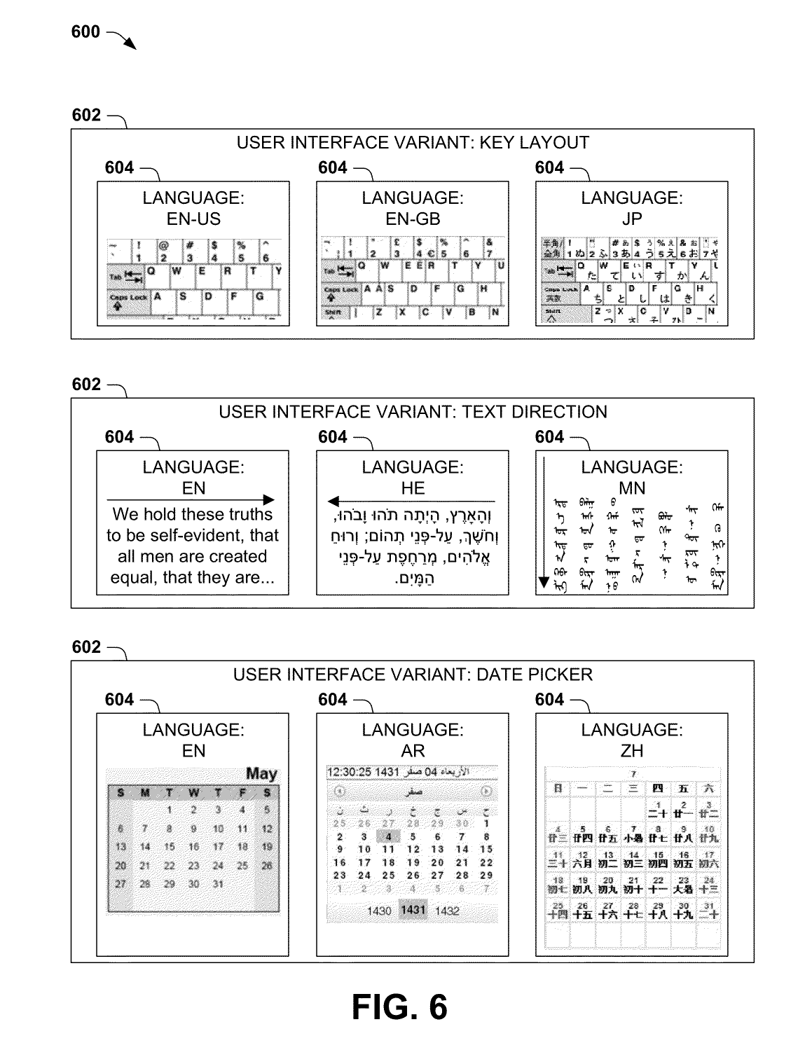

FIG. 6 presents an illustration of an exemplary scenario 600 featuring some examples of user interface aspects 602 that may present different user interface variants 602 for respective languages 108. In this exemplary scenario 600, a first user interface aspect 602 comprises a key layout of an on-screen keyboard 518, and different key layouts may be selected as user interface variants 602 for various languages 108. A second user interface aspect 602 comprises a text direction for a textbox, and various languages 108 may be associated with different user interface variants 604 that alter the behavior of the textbox. A third user interface aspect 602 comprises the presentation of dates, and respective languages 108 may be associated with a user interface variant 604 identifying a different picker interface presenting a different calendar system that is used with the specified language 108.

As a third variation of this third aspect, the breadth of services provided by the application language library 202 may extend beyond languages 108 to related variations.

As a first example of this third variant, the services provided by the application language library 202 may reflect cultural and political views associated with the selected language (e.g., the presentation of a world map with the inclusion and naming of nations and regions according to the cultural standards associated with the language), and the adaptation of language dictionaries used by an application to process communication.

As a second example of this third variant, the services provided by the application language library 202 may also alter the internal operation of an application 106, including communication with other devices 102 and services. For example, the applications 106 executing within the computing environment of the device 102 may include a web browser that is configured to, while communicating with webservers, identify an accept language, and may do so using a selected language 108 identified by the application language library 202. This behavior may be only indirectly or subtly apparent to the user 104 (e.g., adjusting web browser preferences based on cultural or regional variants associated with the selected language 108, such as presenting values in a regional currency format associated with the selected language 108), but may further adapt the device to the linguistic, regional, and cultural details of the user 104. As another example, an application may utilize a resource that is available from a resource store in various resource versions that are associated with various languages 108, and the application language library 202 may assist in the selection of a selected resource version that is associated with a selected language 108, the retrieval of the selected resource version from the resource store, and the provision of the selected resource version in order to bind the resource to the application 108. Those of ordinary skill in the art may devise many such uses by the application language library 202 of the selected languages 108 within the computing environment of the device 102 that may be compatible with and achievable through the techniques presented herein.

### E. COMPUTING ENVIRONMENT

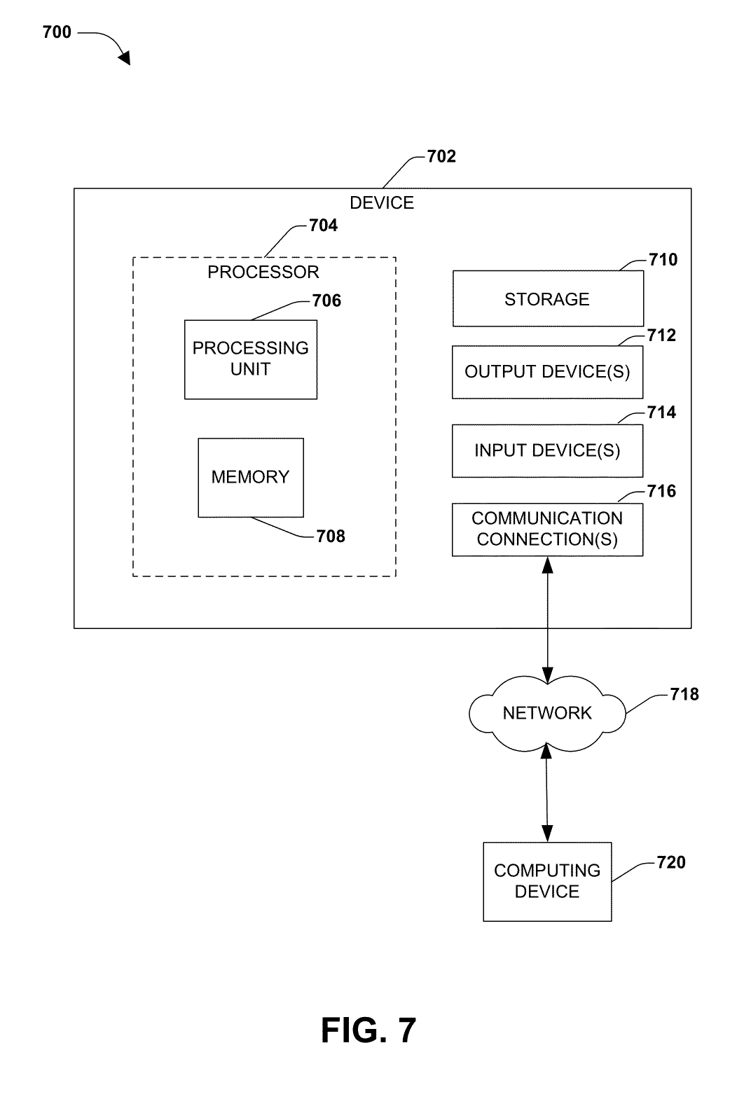

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 702 configured to implement one or more embodiments provided herein. In one configuration, computing device 702 includes at least one processing unit 706 and memory 708. Depending on the exact configuration and type of computing device, memory 708 may be volatile (such as RAM, for example), non-volatile (such as ROM, flash memory, etc., for example) or some combination of the two. This configuration is illustrated in FIG. 7 by dashed line 704.

In other embodiments, device 702 may include additional features and/or functionality. For example, device 702 may also include additional storage (e.g., removable and/or non-removable) including, but not limited to, magnetic storage, optical storage, and the like. Such additional storage is illustrated in FIG. 7 by storage 710. In one embodiment, computer readable instructions to implement one or more embodiments provided herein may be in storage 710. Storage 710 may also store other computer readable instructions to implement an operating system, an application program, and the like. Computer readable instructions may be loaded in memory 708 for execution by processing unit 706, for example.

The term “computer readable media” as used herein includes computer storage media. Computer storage media includes volatile and nonvolatile, removable and non-removable media implemented in any method or technology for storage of information such as computer readable instructions or other data. Memory 708 and storage 710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 702. Any such computer storage media may be part of device 702.

Device 702 may also include communication connection(s) 716 that allows device 702 to communicate with other devices. Communication connection(s) 716 may include, but is not limited to, a modem, a Network Interface Card (NIC), an integrated network interface, a radio frequency transmitter/receiver, an infrared port, a USB connection, or other interfaces for connecting computing device 702 to other computing devices. Communication connection(s) 716 may include a wired connection or a wireless connection. Communication connection(s) 716 may transmit and/or receive communication media.

Device 702 may include input device(s) 714 such as keyboard, mouse, pen, voice input device, touch input device, infrared camera, video input device, gestural device, and/or any other input device. Output device(s) 712 such as one or more displays, speakers, printers, and/or any other output device may also be included in device 702. Input device(s) 714 and output device(s) 712 may be connected to device 702 via a wired connection, wireless connection, or any combination thereof. In one embodiment, an input device or an output device from another computing device may be used as input device(s) 714 or output device(s) 712 for computing device 702.

Components of computing device 702 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 702 may be interconnected by a network. For example, memory 708 may be comprised of multiple physical memory units located in different physical locations interconnected by a network.

Those skilled in the art will realize that storage devices utilized to store computer readable instructions may be distributed across a network. For example, a computing device 720 accessible via network 718 may store computer readable instructions to implement one or more embodiments provided herein. Computing device 702 may access computing device 720 and download a part or all of the computer readable instructions for execution. Alternatively, computing device 702 may download pieces of the computer readable instructions, as needed, or some instructions may be executed at computing device 702 and some at computing device 720.

### F. USAGE OF TERMS

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Additionally, any reference to an application 108 may be applied to the operating system 124 executing on the device 102.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of configuring a device having a processor and an application language library to present applications, the method comprising:
executing on the processor instructions configured to:
present to the user a set of available languages;
upon receiving from a user a selected language, configure the application language library to:
for a text, among a set of text versions in respective languages, present a text version of the text in a selected language;
among a set of user interfaces associated with respective languages, present a user interface associated with a selected language; and
for respective data types, among a set of data formats associated with respective languages, present the data type in a data format associated with a selected language; and
configure applications interacting with users of the device to invoke the application language library.

2. The method of claim 1, respective user interfaces comprising at least one user interface variant associated with a language, the user interface variants selected from a user interface variants set comprising:
a character set;
a key layout;
a text direction; and
a language dictionary associated with the language.

3. The method of claim 2:
respective languages associated with a set of language variants selected from a language variant set comprising:
the selected language used by the application language library to select text versions of text;
the user interface variants of the selected language; and
the data types for respective data formats; and
the instructions further configured to, upon receiving from a user a request to configure a selected language:
present to the user language the language variants of the selected language; and
upon receiving from the user a selection of a selected language variant, configure the application language library to use the selected language variant when using the selected language.

4. The method of claim 1:
at least one language comprising a default language; and
the instructions configured to, before receiving a selected language from the user, initially select a default language.

5. The method of claim 4:
respective languages associated with at least one location; and
the instructions configured to, upon receiving a location associated with a user, select a language associated with the location.

6. The method of claim 1, presenting the available languages comprising: upon detecting a new user of the device, presenting the set of available languages to the new user.

7. The method of claim 1:
the device comprising a control panel providing settings for the device;
presenting the available languages comprising: upon a user accessing a language settings interface of the tool panel, present a list of available languages to the user; and
receiving a selected language comprising: receiving from the user a selection of a list item within the list of available languages.

8. The method of claim 1, receiving a selected language comprising:
receiving user input from the user; and
infer from the user input a selected language of the user.

9. The method of claim 1, the instructions further configured to, upon determining that an invocation by an application of the application language library is incompatible with the selected languages, select a default language for the invocation by the application.

10. The method of claim 9, the default language specified by the application for the invocation.

11. The method of claim 9:
respective languages identifying at least one fallback language; and
the default language comprising a fallback language of a selected language.

12. The method of claim 1:
the instructions further configured to, upon receiving from the user a selection of at least two selected languages, identify a selection order of the languages; and
the application language library configured to select a selected language for an invocation in accordance with the selection order of the selected languages.

13. The method of claim 12:
at least one language comprising a language dialect of a generalized language; and
the instructions further configured to, for respective selected languages comprising a language dialect, insert the generalized language for the language dialect in the selection order after the language dialect.

14. The method of claim 12, the instructions further configured to, for respective invocations by an application:
for respective selected languages, compute a selected language weight representing suitability of the selected language for the invocation; and
configure the application language library to utilize the selected language having a highest selected language weight for the invocation.

15. The method of claim 1, the instructions further configured to, upon the application language library receiving from an application an invocation that is compatible with at least two invocation languages:
present the at least two invocation languages to the user; and
upon receiving from the user a selection of a selected invocation language, configure the application language library to utilize the selected invocation language for the invocation.

16. The method of claim 1:
the applications presented on the device comprising a web browser configured to, while communicating with webservers, identify an accept language; and
configuring the applications comprising: configuring the web browser to, while communicating with webservers, identify an accept language corresponding to a selected language.

17. The method of claim 1:
at least one application utilizing resources available from a resource store as at least one resource version associated with a language; and
the instructions further configured to, upon receiving a request from an application to utilize a resource:
identify a selected resource version associated with a selected language;
retrieve the selected resource version from the resource store; and
provide the selected resource version to the application.

18. The method of claim 1, the instructions configured to, upon receiving an invocation of the application language library to present a text in a selected language:
invoke a translation service to generate a translated version of the text in the selected language; and
present the translated version of the text in the selected language.

19. A computer-readable storage device storing instructions that, when executed on a processor of a device having an application language library, cause the device to present applications by:
presenting to the user a set of available languages;
upon receiving from a user a selected language, configuring the application language library to:
for a text, among a set of text versions in respective languages, presenting a text version of the text in a selected language;
among a set of user interfaces associated with respective languages, presenting a user interface associated with a selected language; and
for a data type, among a set of data formats associated with respective languages, presenting the data type in a data format associated with a selected language; and
configuring applications interacting with users of the device to invoke the application language library.

20. A method of configuring a device having a processor and an application language library to present applications, the method comprising:
executing on the processor instructions configured to:
present to the user a set of available languages including a default language, respective languages associated with a set of language variants selected from a language variant set comprising:
a language used by the application language library to select text versions of text;
at least one user interface variant of the language, the user interface variants selected from a user interface variants set comprising:
a keyboard layout;
a language character set;
a text direction; and
a language dictionary associated with the language; and
the data types for respective data formats;
before receiving a selected language from the user, initially select the default language;
upon receiving from a user a selected language, configure the application language library to:
for a text, among a set of text versions in respective languages, present a text version of the text in a selected language;
among a set of user interfaces associated with respective languages, present a user interface comprising the user interface variants associated with a selected language;
for a data type, among a set of data formats associated with respective languages, present the data type in a data format associated with a selected language;
upon receiving user input from the user, infer from the user input a selected language of the user;
upon receiving from a user a request to configure a selected language:
present to the user language the language variants of the selected language; and
upon a user accessing a languages settings interface of the tool panel:
present a list of available languages to the user;
receive from the user a selection of a list item within the list of available languages; and
upon receiving from the user a selection of a selected language variant, configure the application language library to use the selected language variant when using the selected language;
upon receiving from the user a selection of at least two selected languages, identify a selection order of the languages;
upon receiving a selection of a selected language comprising a language dialect of a generalized language, insert the generalized language for the language dialect in the selection order after the language dialect;
configure applications interacting with users of the device to invoke the application language library;
upon the application language library receiving an invocation by an application:
among at least two selected languages, select a selected language for an invocation in accordance with the selection order of the selected languages by:
for respective selected languages, computing a selected language weight representing suitability of the selected language for the invocation;
configuring the application language library to fulfill the invocation using the selected language having a highest selected language weight for the invocation; and
upon receiving from the user a selection of a selected invocation language, configure the application language library to utilize the selected invocation language for the invocation;
upon receiving an invocation requesting a presentation of a text:
present the text in a text version associated with a selected language; and
upon receiving an invocation of the application language library to present a text in a selected language:
invoke a translation service to generate a translated version of the text in the selected language; and
present the translated version of the text in a selected language;
upon receiving an invocation requesting a presentation of a user interface, present a user interface comprising user interface variants associated with a selected language;
upon receiving an invocation requesting a presentation of a data type, present the data type in a data format associated with a selected language;
upon receiving a request from an application to utilize a resource:
identify a selected resource version associated with a selected language;
retrieve the selected resource version from the resource store; and
provide the selected resource version to the application; and
upon determining that the invocation is incompatible with the selected languages in the selection order, select a default language specified by the application for the invocation.
